(19) United States
(12) Patent Application Publication
(10) Pub. No.: US 2008/0258432 A1
(43) Pub. Date: Oct. 23, 2008

(54) Trailer Coupling

(76) Inventor: James Henry Haslam, Preston (GB)

Correspondence Address: MICHAEL BEST & FRIEDRICH LLP, 100 E WISCONSIN AVENUE, Suite 3300, MILWAUKEE, WI, 53202, US

(21) Appl. No.: 10/549,519

(22) PCT Filed: Mar. 1, 2004
(86) PCT No.: PCT/GB04/00853

§ 371 Date: Sep. 21, 2007

(30) Foreign Application Priority Data
Mar. 15, 2003 (GB) 0305992.0

(51) Int. Cl. B60D 1/00

(52) U.S. Cl. 280/504

(57) ABSTRACT

A trailer coupling apparatus comprising means (6, 8) to pivotably mount at least one left wheel and at least one right wheel to a trailer (3), independent means (12) to pivotably connect the trailer (3) to a towing vehicle (5) and means to enable differential pivoting of the said wheels and trailer, with respect to the towing vehicle, as the towing vehicle is turned in use.

### FIELD OF THE INVENTION

This invention relates to a trailer coupling apparatus and methods of coupling trailers to a towing vehicle.

### BACKGROUND TO THE INVENTION

It is known to provide a towing vehicle to which is connected a trailer such as a goods wagon or flat-back wagon, and in which the trailer is pivotably connected to the towing vehicle. The pivotable connection is needed in order to ensure that when the towing vehicle is steered to the left or right, the trailer may also move correspondingly to the left or the right in order to prevent undue stress on the wheels and/or axles of the trailing vehicle, and to facilitate smooth and safe turning of towing vehicle and trailer.

There are various different types of trailers which may be coupled to towing vehicles. In particular, lorry chassis generally have a pivot point into which a pivot bar of a lorry trailer may be inserted, and about which the lorry trailer may pivot upon turning of the lorry chassis. The trailer may include a central axle or axles, such that the trailing vehicle is finely balanced on the central axle(s) when connected to the towing vehicle. This particular configuration allows good turning characteristics of the towing vehicle and trailer, both in forward and reverse directions, but is relatively unstable in that any goods contained within the trailer must be finely balance in order that the trailer does not overbalance towards the front or rear of the trailer, and thus create instability in the towing vehicle-trailer coupling and the driving characteristics of the towing vehicle.

A second type of trailer provides front and rear axles on the trailer, such that the trailer is adequately balanced whatever the orientation of the goods are lowered within the trailer. This type of trailer may include a tow bar in the form of in the form of an “A-frame”, and connected to the front of the trailer and which, at the apex of the “A” comprises either a towing pin or a towing aperture, which pivotably connects with a corresponding towing aperture or towing pin on the towing vehicle. The front axle of this type of trailer generally comprises a turntable on which the axle is mounted, such that the front axle may freely pivot with the turntable, as the lorry chassis, or any other towing vehicle turns. The system is adequate for forward movement and steering of the towing vehicle, but problems can arise when it is desired to reverse the vehicle and trailer, such as in order to reverse into a goods yard or the like for example.

As the turntable with which the axle rotates is freely rotatable, when a towing vehicle reverses and steers left or right at the same time, the trailer has a tendency to overcompensate in pivoting about the pivotable connection between the trailer and the towing vehicle, such that the wheels connected to the turntable on the trailer effect “jack-knifing” or folding up of the trailer towards the towing vehicle. Obviously, this can be dangerous and may cause unnecessary damage to the towing vehicle and/or trailer.

It would therefore be advantageous to provide a trailer coupling apparatus which enables a trailer to be pivotably connected to a towing vehicle, and which enables effective and safe forward and reverse steering of the towing vehicle.

It would also be advantageous to provide a trailer coupling apparatus which enabled at least one set of left and right wheels on a trailing vehicle to be oriented in a substantially optimal direction with respect to the orientation of the towing vehicle, when, in use the towing vehicle is steered left or right.

It is therefore an aim of preferred embodiments of the invention to overcome or mitigate at least one problem of the prior art, whether expressly disclosed herein or not.

### SUMMARY OF THE INVENTION

According to a first aspect of the invention there is provided a trailer coupling apparatus comprising means to pivotably mount at least one left wheel and at least one right wheel to a trailer, independent means to pivotably connect the trailer to a towing vehicle and means to enable differential pivoting of the said trailer wheels and trailer, with respect to the towing vehicle, as the towing vehicle is turned in use.

By “trailer” we mean any wheeled vehicle or wheeled apparatus which may be towed by a vehicle, such as a goods trailer, flat-back trailer, caravan, electrical generator and the like, for example. Particularly suitable as a trailer is a goods trailer.

Preferably the trailer coupling apparatus further comprises the at least one left wheel and at least one right wheel.

Preferably the trailer comprises a trailer chassis to which is mounted a rear set of preferably fixed wheels and the coupling apparatus preferably comprises a front set of wheels which can be pivotably mounted to the trailer.

The pivotable wheels of the apparatus may be connectable to an axle which is mounted on a pivotable member, such as a turntable. The axle may be positioned towards the centre of the turntable, but is preferably positioned towards the rear of the turntable, with respect the direction of the trailer to which it is mounted. The axle and/or turntable may comprise part of the trailer or part of the coupling apparatus.

Alternatively the pivotable wheels may be connected to pivotable kingpins, said kingpins being preferably connectable to the chassis or a sub-frame of the trailer.

The pivotable connection means may comprise a suspension means, and/or means to bias the connection means onto the towing vehicle, in use.

Preferably the means to pivotably connect the trailer to a towing vehicle comprises a tow bar.

Preferably the tow bar comprises a female or male member at the distal end thereof, arranged in use to cooperate with a corresponding male or female member on the towing vehicle.

The tow bar may comprise an A-frame, wherein suitably the apex of the frame comprises the male or female member.

The tow bar may comprise means to prevent the distal end of the tow bar from falling to ground level when it is not coupled to a towing vehicle, and may comprise biasing means, arranged to bias the distal end of the tow bar away from the ground. The biasing means which prevent the distal end of the tow bar from falling to ground level may be the same biasing means arranged to bias the connection means onto a towing vehicle, in use, for example when the tow bar is arranged to connect to the underside of the towing vehicle. The biasing means may comprise any suitable means, such as a spring for example.

The pivotable wheels are preferably arranged to pivot in the turning direction of the towing vehicle, in use. Thus the pivotable wheels preferably pivot into the turn made by the towing vehicle in use.

The means to effect differential pivoting of the pivotable wheels and the trailer may comprise restriction means, arranged in use to delay or reduce the magnitude of pivoting of the wheels with respect to the trailer until the towing vehicle has turned a prescribed angle.

The restriction means may effect restriction of pivoting of the pivotable wheels of the trailer to a fraction of the angle effected between the trailer and a towing vehicle chassis upon turning/pivoting of a towing vehicle to which the trailer is connected, in use, until the towing vehicle has turned a prescribed angle.

Suitably the restriction means enables movement of the pivotable wheels of the trailer in the direction a towing vehicles turns, in use, and effects a restricted angle of turning of the pivotable wheels in relation to the turning arc of the towing vehicle.

Preferably the restriction means comprise means to enable substantially optimal orientation of the pivotable wheels of the trailer, in relation to the orientation of the towing vehicle, in use, as the towing vehicle is turned.

Suitably the restriction means effects restriction of pivoting of the wheels to an angle of no more than 85%, preferably no more than 75%, more preferably no more than 65% and most preferably no more than 60% of the angle turned by the towing vehicle. Suitably the restriction means effects restriction of pivoting of the wheels to an arc of no more than 90°, preferably no more than 85°, more preferably no more that 80° and most preferably no more than 75°.

As the pivotable wheels are restricted to pivoting in a defined smaller arc with respect to the trailer or delayed in pivoting with respect to the trailer, during reversing of a towing vehicle and the trailer, the pivotable wheels cannot pivot past the angle formed between the towing vehicle and trailer in relation to the direction of the trailer and thus, the wheels are prevented from pivoting such that the trailer turns in on the towing vehicle or jack-knifes. Thus the restriction means may enable safer reversing as compared to towed trailers not utilising the trailer coupling apparatus of the invention.

The restriction means preferably comprises a steering member, movably mountable on a channel member. Utilising a steering member mounted in a channel has the effect of enabling translation of at least part of the rotational movement between the towing vehicle and trailer into linear movement of the steering member in the channel and thus the angle between the towing vehicle and trailer will be the prescribed angle greater than the angle of the pivotable wheels relative to the trailer front.

The channel member preferably comprises an open end and a closed end.

Preferably the open end is operably cooperable with the steering member to enable movement between the steering member and the channel member.

Suitably the closed end is arranged, in use to restrict movement of the steering member to within the channel member.

The steering member may be connected to the pivotable wheels and the channel member may be connectable to the towing vehicle, in use. Alternatively the channel member may be connected to the pivotable wheels and the steering member connectable to the towing vehicle, in use.

The steering member may comprise a steering bar.

Suitably the steering bar comprises a protruding member at or near the distal end thereof, arranged to cooperate with the channel member of the restriction means.

The protruding member may comprise a substantially spherical member and the channel member may comprise a channel of substantially cylindrical cross-section. The channel member preferably comprises means to prevent removal of the steering member from the channel member other than by way of the open end. The channel member may comprise releasable securement means, arranged to releasably secure the steering member within the channel member until it is desired to release it.

The steering member or channel member may include a plurality of gear teeth, arranged to cooperate with a corresponding plurality of teeth on a turntable to which the pivotable wheels are connected.

In alternative embodiments the restriction means may comprise a plurality of pivotable arms, at least one of which is connectable to the pivotable wheels and at least one of which is pivotably connectable to a towing vehicle, in use, and wherein the maximum pivotable arc achievable by the pivotable wheels is restricted by the maximum pivot achievable by the plurality of arms.

The restriction means may comprise a telescopic member. Thus the delay in pivoting of the pivotable wheels in relation to turning of the towing vehicle, in use, will be determined by the minimum or maximum length of the telescopic member.

The means to pivotably connect the trailer to a towing vehicle may also comprise a telescopic tow bar. Thus, utilisation of a telescopic tow bar enables the trailer coupling apparatus to be connected to a plurality of different trailer-towing vehicle combinations which require different minimum or maximum coupling distances, or space between the trailer and towing vehicle.

The apparatus may comprise secondary restriction means, which in use, are connectable to the trailer and which restrict upward and downward movement of the pivotable wheels during turning of the trailer.

The secondary restriction means may comprise one or more buffers co-operable with each pivotable wheel and which are arranged to protrude towards the ground from the trailer adjacent to the trailer's front wheel axle or axles. There may be a buffer arranged to be located in front of the or each axis and behind the or each axle. The buffer or buffers may be constructed from any suitable material, such as rubber, for example.

Thus at high speeds when the front axle or axles are parallel with the direction of travel, the axle(s) may move up and down with the suspension freely. At lower speeds, if the front axle or axles pivot during turning of the trailer, part of the or each axle will move underneath the or each buffer and be prevented from moving fully upwards towards the underside of the trailer by the buffer(s).

According to a second aspect of the invention there is provided a trailer comprising at least one pivotable front left and right wheels, and further comprising means to independently pivotably connect the trailer to a towing vehicle and means to enable differential pivoting of the trailer wheels and trailer, in relation to the towing vehicle as the towing vehicle is turned, in use.

Suitably the trailer comprises a rear set of wheels in addition to the front set of wheels. The rear set of wheels are preferably a fixed non-pivotable set of wheels.

Suitably the pivotable wheels are mounted to a turntable located beneath the trailer. The turntable is preferably as described for the first aspect of the invention.

Preferably the means to independently pivotably connect the trailer to a towing vehicle and means to enable differential pivoting of the trailer wheels and trailer are as described for the first aspect of the invention.

According to a third aspect of the invention there is provided a method of connecting a trailer to a towing vehicle, comprising the steps of:
(a) connecting means to pivot at least one front left and right wheel to the trailer;
(b) connecting means to independently pivotably connect the trailer to a towing vehicle, to the trailer and towing vehicle; and
(c) connecting means to effect differential pivoting of the said trailer wheels and trailer to the trailer and towing vehicle.

Steps (a), (b) and (c) may be performed in any suitable order.

The means to pivotably mount the wheels to the trailer, means to pivotably connect the trailer to a towing vehicle and means to differentially pivot the trailer wheels and trailer are preferably as described for the apparatus and trailer of the first and second aspects of the invention.

### BRIEF DESCRIPTION OF THE DRAWINGS

For a better understanding of the invention and to show how embodiments of the same may be put into effect, the various aspects will now be described by way of example only, with reference to the accompanying drawings, in which:

FIG. 1 illustrates a first embodiment of a trailer coupling apparatus of the invention, in plan view, connected to a trailer and a towing vehicle;

FIG. 1A illustrates a side view of the trailer coupling apparatus of FIG. 1;

FIG. 1B illustrates an end cross sectional views of the parts of the restriction member of the trailer coupling apparatus of FIGS. 1 and 1A;

FIGS. 2A to 2C illustrates plan schematic views of movement of a trailer and pivotable wheels when coupled to a towing vehicle using the trailer coupling apparatus of the invention;

FIG. 3 illustrates a plan view of a second embodiment of a trailer coupling apparatus of the invention coupled to a towing vehicle;

FIG. 4 illustrates a third embodiment of a trailer coupling apparatus of the invention coupled to a trailer;

FIG. 5A illustrates a side cross sectional view of a second restriction means of a trailer coupling apparatus of the invention;

FIG. 5B illustrates a plan cut away sectional view of the secondary restriction means shown in FIG. 5A, connected to a flat-back trailer;

FIG. 5C illustrates a side view of the secondary restriction means shown in FIGS. 5A and 5B;

FIG. 5D illustrates a plan view of part of the secondary restriction means shown in FIGS. 5A and 5B;

FIG. 5E illustrates a plan view of the flat-back trailer shown in FIGS. 5A and 5B, in which pivotable wheels have been pivoted beneath the trailer;

FIG. 5F illustrates a side sectional view of the flat-back trailer of FIGS. 5A, 5B and 5E in which the pivoted axle of the pivotable wheels is restricted by the secondary restriction means of the apparatus of the invention;

FIG. 6 illustrates a fourth embodiment of a trailer coupling apparatus of the invention in plan view, connected to a trailer and a towing vehicle;

FIG. 7 illustrates a plan view of a fifth embodiment of a trailer coupling apparatus of the invention connected to a trailer and a towing vehicle;

FIG. 7A illustrates a side view of the embodiment of the trailer coupling apparatus of FIG. 7;

FIG. 8 illustrates a sixth embodiment of the trailer coupling apparatus of the invention connected to a trailer and a towing vehicle;

FIG. 8A illustrates a side view of the embodiment of the trailer coupling apparatus shown in FIG. 8;

FIG. 9 illustrates a plan view of a sixth embodiment of the trailer coupling apparatus of the invention coupled to a trailer and a towing vehicle;

FIG. 9A illustrates a side view of the embodiment of the trailer coupling apparatus shown in FIG. 9;

FIG. 10 illustrates a plan view of a seventh embodiment of the trailer coupling apparatus of the invention coupled to a trailer and a towing vehicle;

FIG. 10A illustrates a side view of the embodiment of the trailer coupling apparatus shown in FIG. 10;

FIG. 11 illustrates a plan view of an eighth embodiment of the trailer coupling apparatus of the invention coupled to a trailer and a towing vehicle;

FIG. 12 illustrates an embodiment of a towing bar usable in the trailer coupling apparatus of the invention connected to a towing vehicle;

FIG. 13 illustrates a plan view of a ninth embodiment of the trailer coupling apparatus of the invention, coupled to a trailer and a towing vehicle;

FIG. 13A illustrates a side view of the trailer coupling apparatus shown in FIG. 13; and

FIG. 14 illustrates a plan schematic view of the trailer coupling apparatus of FIGS. 13 and 13A, coupled to a trailer and towing vehicle, wherein the trailer and towing vehicle are pivoted relative to one another about the trailer coupling apparatus.

### DESCRIPTION OF THE PREFERRED EMBODIMENTS

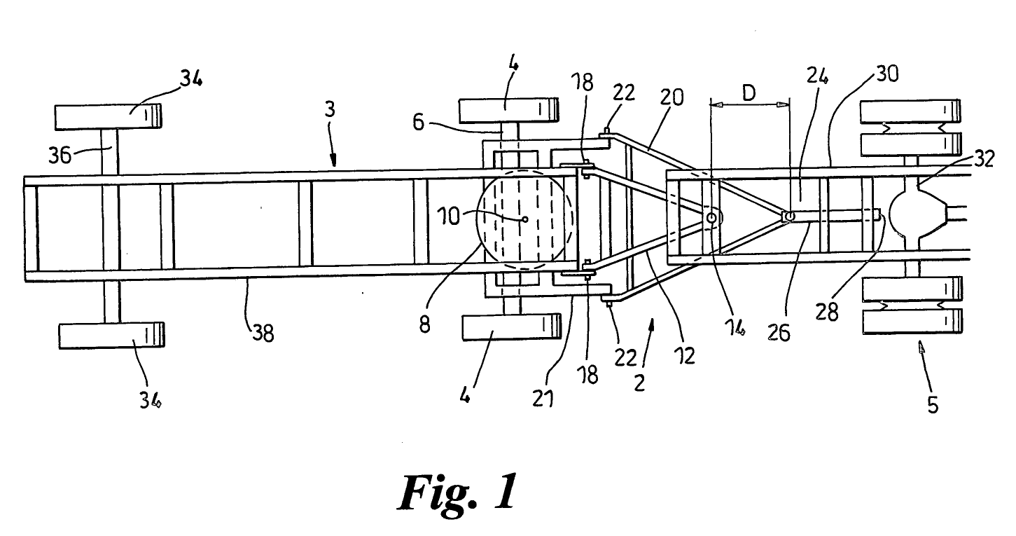

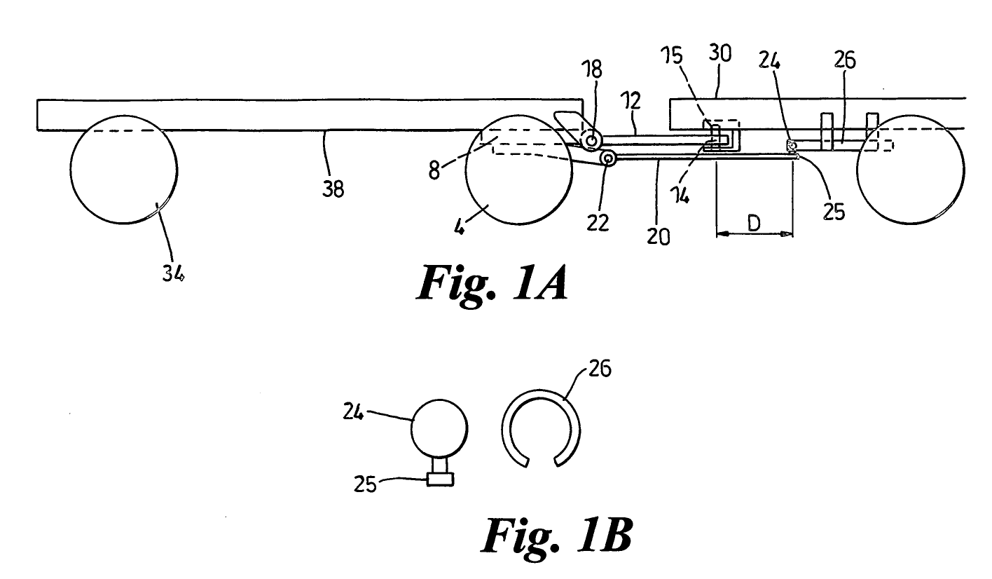

We refer firstly to FIGS. 1, 1A and 1B, which illustrate a first embodiment of a trailer coupling apparatus 2 of the invention. The trailer coupling apparatus comprises means to pivotably mount front left and right wheels on a trailer chassis 38, in the form of a turn table 8, on which is mounted a fixed axle 6 at either end of which are mounted the wheels 4. The turntable 8 is mounted on a single pivot point 10 connectable to the chassis 38 of the trailer. The trailer coupling apparatus 2 further comprises means to pivotably connect the trailer to a towing vehicle 5, in the form of an “A-frame” tow bar 12, which at the distal end of the legs of the “A” are connected to the trailer chassis 38 via hinges 18. The apex of the A-frame 12 is connectable to the towing vehicle 5 by way of a pivot aperture 14 operably connectable to a pivot bar on the towing vehicle 5, located at or towards the rear of the towing vehicle 5 chassis 30. The trailer coupling apparatus 2 further comprises means to effect differential pivoting of the trailer wheels 4 and trailer 3 as the towing vehicle is turned in use, in the form of an A-frame steering bar 20, connected to a steering frame 21, which is in turn connected to the pivotable turntable 8 of the coupling apparatus 2. The A-frame steering bar 20 is connected to the steering frame 21 via hinges 22 located at the distal ends of the legs of the “A” at the apex 25 of the “A” frame 20 is located a connection ball 24 which is substantially spherical. Also comprising part of the means to enable differential pivoting is a slide channel 26 comprising a substantially cylindrical hollow cross section having an open channel there along. The slide channel 26 includes at its distal end thereof a closed channel end 28. The ball within the slide channel 26 is dimensioned to allow insertion of the connection ball 24 of the A-frame steering bar 20, such that the connection ball 24 may slide along the slide channel 26 up to the closed end 28. The trailer coupling apparatus 2 is connected such that the turntable 8 is connected to the chassis 38 of the trailer 3 at the front end thereof. The trailer 3 also comprises at its rear end a fixed rear axle 36 on which are mounted rear left and right wheels 34. The slide channel 26 is connected to the rear of the chassis 30 on a towing vehicle 5, such that the open end thereof faces the rear of the towing vehicle 5. The slide channel 26 is connected just behind the rear axle 32 of the towing vehicle.

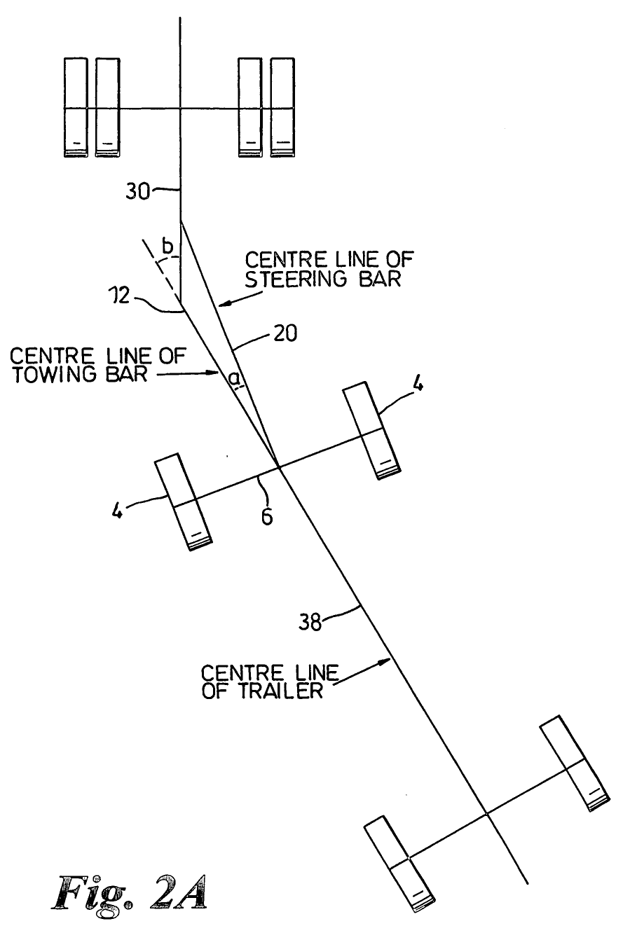

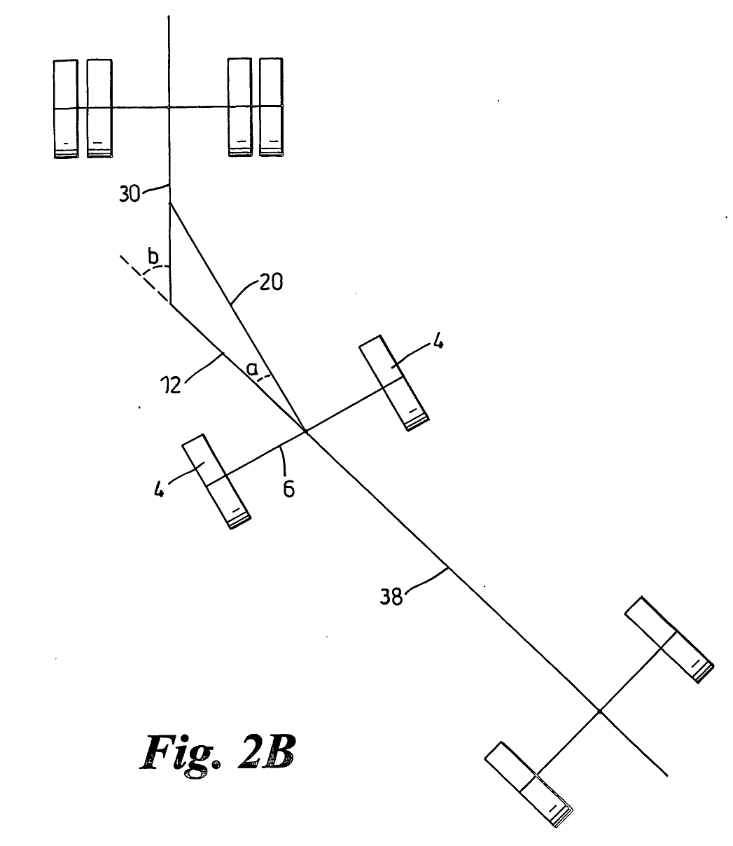

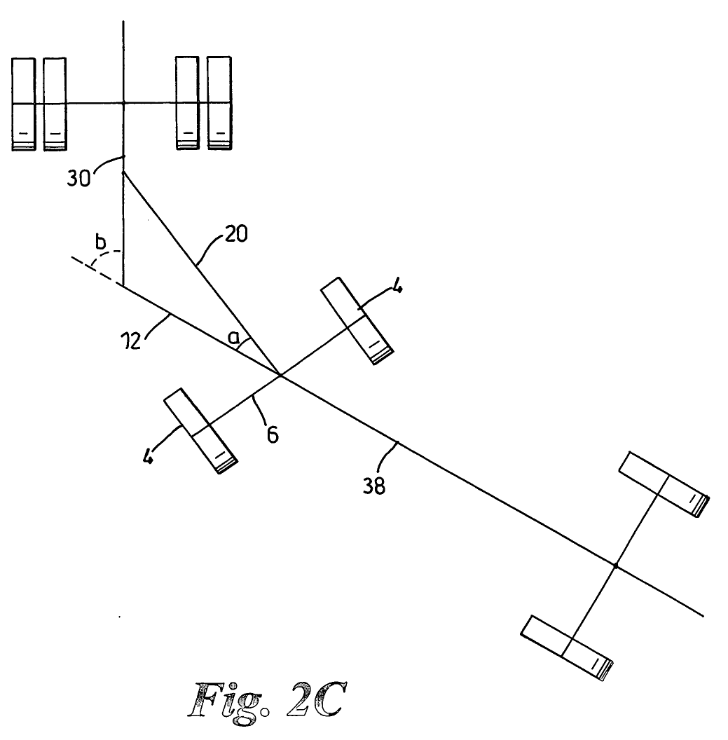

Use of the trailer coupling apparatus 2 of FIG. 1 will now described with reference to FIGS. 1, 1A, 1B and FIGS. 2A to 2C. The slide channel 26 is firstly connected to the underside of the rear of a chassis 30 of a towing vehicle, by a suitable means. Alternatively, the slide channel 26 may be integral with the chassis 30 in new vehicles. The steering frame 21 is connected to the underside of the front of a trailer 3 such that the turntable 8 is pivotably connected under the chassis 38, and thus the front left and right wheels 4 are pivotably mounted on the chassis 38. The tow bar 12 of the apparatus 2 is then connected to the chassis 30 of the towing vehicle 5 by way of the towing aperture 14 of the tow bar 12 being connected to the towing pin 15 connected to or integral with the chassis 30 of the towing vehicle. As the tow bar 12 is hingedly connected on hinges 18, if the towing vehicle 5 and trailer 3 move over uneven ground, the difference in heights between the towing vehicle 5 and trailer 3 are compensated by pivoting of the tow bar 12 at the hinges 18. The steering bar 20 is then connected to the slide channel 26 on the chassis 30 of the towing vehicle 5 by manipulation of the steering ball 24 into the ball of the slide channel 26, by reversing the towing vehicle towards the steering ball 24 and manipulating the steering ball 24 by any suitable means. The slide channel 26 also includes a tow bar release prevention means (not shown) which can be connected around the open end of the slide channel 26 such that when the tow bar is within the bore of the channel 26, it can not be removed from the open end until the release means are activated. Any suitable release prevention means may be utilised as are known to automotive engineers.

Thus, the trailer coupling apparatus 2 is connected to both the trailer 3 and the towing vehicle 5 in order to couple the two together.

As the slide channel 26 has a finite length, the tow ball 24 may move slidably, forward and reverse along the finite length during movement of the trailer 3 and towing vehicle 5 during driving.

When the towing vehicle 5 travels in a straight line, the towing ball 24 will be drawn back to the rear open end of the slide channel 26 (but prevented from leaving the open end by the release means (not shown)), and by the limited rear movement available due to the specific connection between the tow bar 12 and pivot bar 15. As the towing vehicle 5 is turned to the right during driving (the following description is equally applicable to turning to the left, but for clarity only turning to the right will be described), the towing vehicle 5 is pivoted relative to the trailer about the pivot aperture 14 and pivot bar 15 connecting the trailer 3 to the towing vehicle 5, to form an angle b as shown in FIGS. 2A to 2C. The further the vehicle turns, the greater angle b becomes and the greater the angular difference between the centre line of the towing bar and trailer chassis to the direction of the towing vehicle chassis and wheels. As the towing vehicle 5 turns further to the right, the chassis 30 of the towing vehicle 5 becomes offset with respect to the steering bar, thus translating the rotational movement to linear movement in urging the steering ball 24 to move linearly forward within the slide channel 26 towards the closed end 28. As the steering ball 24 is able to slide along the channel 26, the pivotable wheels 4 are restricted to a lesser magnitude of pivoting by the concurrent linear movement of the ball 24 (and hence steering bar 20). Therefore the wheels 4 will always be restricted to a smaller pivotable angle with respect to the towing vehicle. Eventually, the steering ball 24 will substantially abut the closed end 28 of the slide channel 26, and thus be restricted from moving any further.

FIGS. 2A to 2C illustrate the relative differential angles of the pivotable wheels 4 and steering bar 20 of the coupling means 2 with respect to the direction of the towing vehicle chassis 30 during a right turn of said towing vehicle 5, compared to the differential angle obtained between the centre line of the towing bar 12 as compared to the chassis 30 of the towing vehicle 5 during the same turn. It can be seen that during a right turn, the pivotable front wheels 4 having been reduced in pivoting are then always at a reduced angle in relation to the towing vehicle 5 as compared to the angle between the chassis 38 of the trailer 3 and the towing vehicle 5. Thus, for reversing the towing vehicle 5, the restriction of movement prevents the pivotable wheels 4 from over pivoting such that the trailer body and trailer chassis 38 of the trailer 3 fold in or jack knife. The trailer coupling apparatus 2 serves to facilitate safe and efficient turning, and especially reverse turning of a trailer coupled to a towing vehicle.

The steering bar 20 is also biased upwardly by a resilient biasing means such as spring (not shown), in order that when the towing vehicle 5 is uncoupled from the trailer 3, the steering bar 20 is urged away from the ground level. The resilient biasing means also helps to facilitate connection of the steering bar 20 with the slide channel 26 during connection and disconnection. The slide tube may also be funnel shaped towards the open end thereof to assist coupling of the steering ball 24 and the bore of the slide channel 26.

The distance D shown on FIG. 1, between the tow bar 12 connection with the chassis 30 of the towing vehicle 5 and the tow ball 24 connection with the slide channel 26 at its rear most open end, can be increased or decreased, to obtain different steering characteristics, under steer or over steer etc between the towing vehicle and trailer during turning of the towing vehicle. The slide tube 26 may also be connected at an incline with respect to the chassis 30 of the towing vehicle 5 in order to change the steering characteristics.

The axle 6 mounted on the turntable 8 of the coupling apparatus 2 is towards the rear of the turntable, facilitating the steering to self centre during forward linear motion of the towing vehicle 5 and trailer 3, and also has the advantage that when the vehicle turns to the left or right, the axle moves to the left or right respectively giving greater stability to the trailer 3. The axle 6 could however be positioned across the centre of the turntable 8.

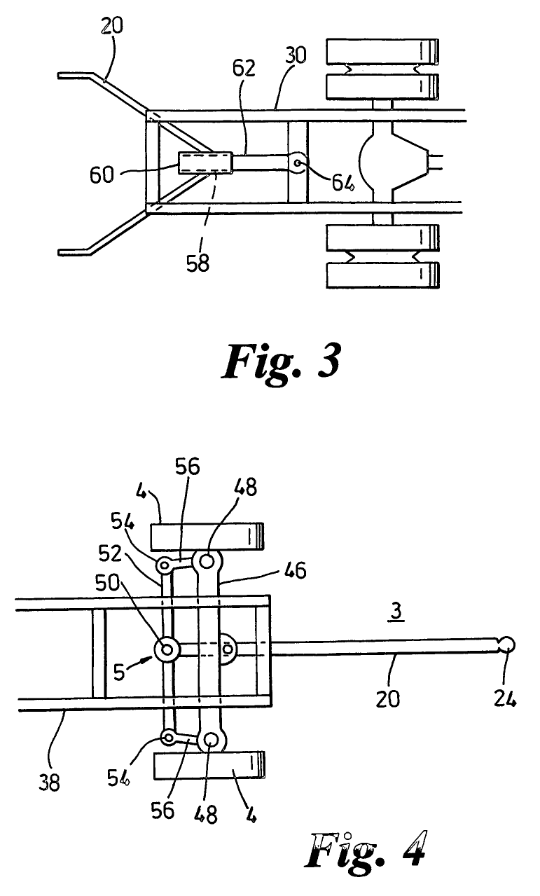

We turn now to FIG. 3 which illustrates a second preferred embodiment of the means to enable differential pivoting of the trailer wheels and trailer as the towing vehicle is turned in use, in the form of a second steering bar 20 system. In this system, the steering bar 20 also comprises an A-frame. Like numerals represent like components. The A-frame 20 of FIG. 3 extends to an apex on which is mounted a hollow cylinder bracket 58, having a bore there through, and having a closed end 60 at the proximal end to the trailer 3 to which it is connected (not shown). Located within the cylinder bracket 58 is a slide tube 62, which in use is able to slide forwards and backwards within the bracket 58. The slide tube 62 is connected to the chassis 30 of a towing vehicle 5 by way of a pivot 64. The slide tube 62 is prevented from being removed from the bracket 58 by any suitable restriction means such as a collar perpendicular to the body of the bracket 58, around the open end of the bracket 58 (not shown), for example. This embodiment is useful for when the space on the towing vehicle 5 is restricted, and use of this embodiment is very similar to use of the embodiment shown in FIGS. 1 and 1A, except that any variation in coupling length between the trailer 3 and towing vehicle 5 is accommodated by sliding movement of the slide tube 62 within the bracket 58. This steering bar 20 would give different steering characteristics to the steering bar 20 shown in FIGS. 1 and 1A. All of the other components of the coupling apparatus 2 not shown in the embodiment shown in FIG. 3 are identical to those of FIGS. 1 and 1A, including the pivotable wheels 4, tow bar 12 and turntable 8.

We turn now to FIG. 4 which illustrates part of a third preferred embodiment of a trailer coupling apparatus 2 of the invention. This embodiment is similar to that shown in FIGS. 1 and 1A, and like numerals represent like components. The means to enable differential pivoting of the trailer in the embodiment shown in FIG. 4 comprises a steering bar 20 which in this case is not connected to a turntable, but to kingpins 48 which allow pivoting of front left and right wheels 4. The steering bar 20 includes at the distal end thereof a steering ball 24 which is arranged to cooperate with the slide channel identically to that of FIGS. 1 and 1A. The other end of the steering bar 20 comprises a pivot 5 which is connected to a secondary steer bar having at either end thereof secondary pivots 54 on which are mounted kingpin connection bars 56. The embodiment shown in FIG. 4 works the same way as those of the embodiments of FIGS. 1, 1F and 3 except that when the towing vehicle is turned to the left or right, corresponding pivoting of the steering bar 20 is achieved about pivot point 50, which causes pivoting—to—lateral movement of the secondary steering bar 52, which in turn causes pivoting of the kingpin connection bars 56 to pivot the kingpins 48 and thus pivot the front left and right wheels 4.

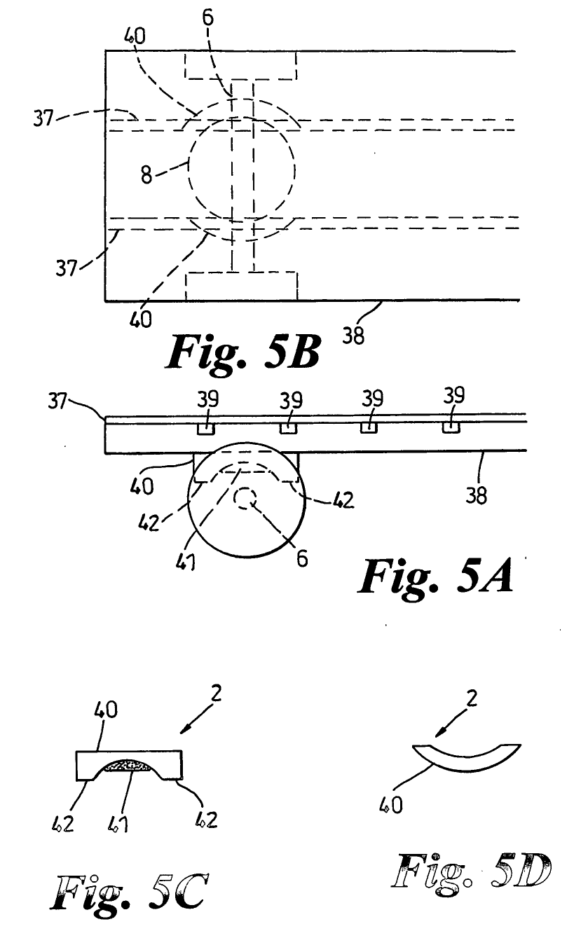

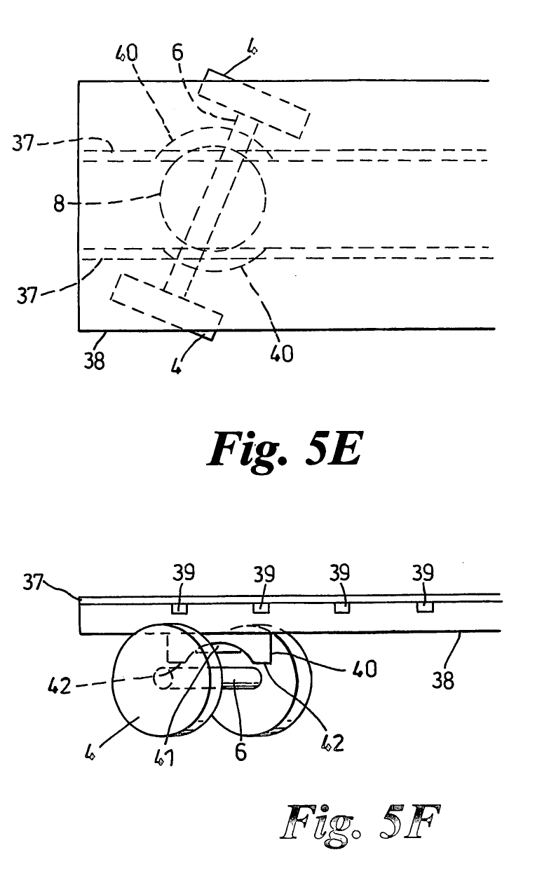

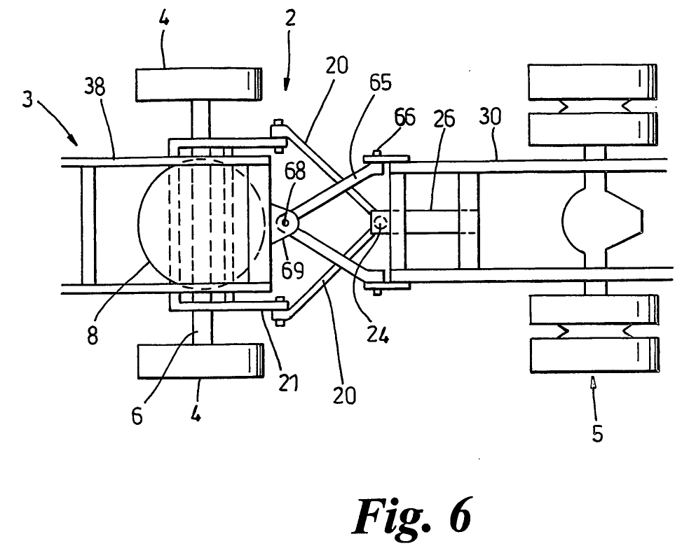

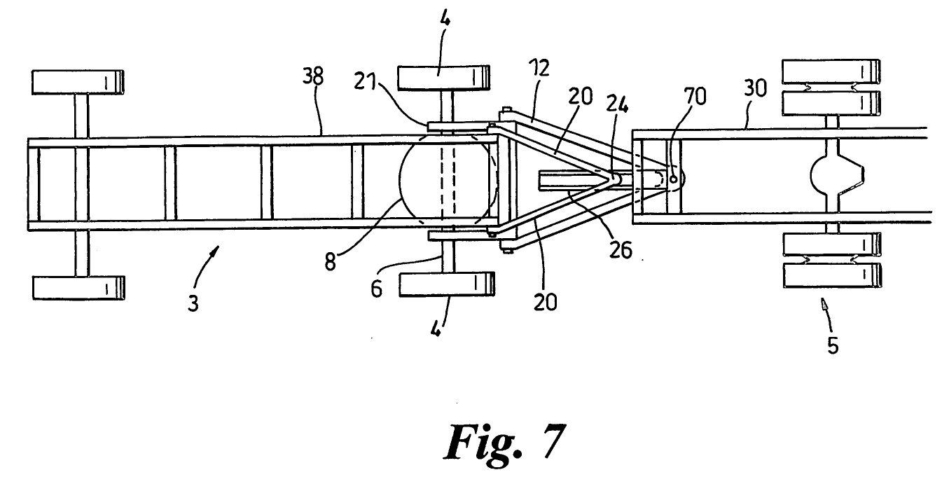

We turn now to FIGS. 5A to 5F. The coupling apparatus 2 of the embodiment shown in FIGS. 1, 1A, and 3, or any other embodiments in which a rotatable turntable are used, may include a secondary restriction means in the form of buffer members 40, as shown in FIGS. 5A to 5F, which in use are arranged adjacent to the turntable 8. The buffers 40 comprise partial toroid shapes, which include pendent portions 42, arranged to depend either side of the axle 6 of the coupling apparatus 2 of the invention shown in FIGS. 1, 1A and 3. The buffer members 40 also include a compressible material 41 between the pendent members 42, and which is arranged directly above the axle 6 when the axle 6 is perpendicular to the trailer chassis 38 during forward movement of the trailer 3. Thus in use, as the trailer 3 moves forward, the axle 6 may, through any suitable suspension, move up and down with respect the trailer chassis 38, and if for example the trailer 3 goes over a large bump, the axle 6 may abut and compress the compressible material 41 of the buffers 40 in order to prevent damage to the axle 6 or chassis 38. During turning of the trailer 3, as the wheels 4 are pivoted about turntable 8, the distal regions of the axle 6 move adjacent and under the pendent portions 42 of the buffer members 40. In this position, as shown in FIGS. 5e and 5f, the axle 6 is restricted in its upward movement due to the lower pendency of the pendent 42 compared to the centre region of the buffer member 40 which comprises the compressible material 41. Thus upward movement of the axle 6 is restricted during turning of the trailer and wheels 4 at low speeds. When travelling at low speed, full upward movement of the axle 6 on the trailer 3, is not needed and when the trailer front axle turns enough to move underneath the pendent portions 42, the upward movement of the axle 6 is limited by said portions. The buffer members 40 are attached to the chassis 38, rather than the steering frame 21 of the apparatus 2. Alternatively the buffer members 40 may be mounted on the axle 6 itself rather than chassis 38 of the trailer 3.

This layout allows the trailer front wheels 4 to be placed between two cross-members 39 on the trailer 3, and thus allows a lower body height than could otherwise be obtained.

We turn now to FIG. 6 which illustrates another preferred embodiment of a trailer coupling apparatus 2 of the invention which is similar to the coupling apparatus 2 of FIGS. 1 and 1A. Like numerals represent like components. In this embodiment, a tow bar 65 is included which is hingedly connected to the chassis 30 of towing vehicle 5 rather than the chassis 38 of the trailer 3, via hinges 66 at the ends of the legs of the A-frame of the tow bar 65. The apex of the A-frame comprises a pivot bar 68 which is arranged to connect to a pivot aperture 69 on the chassis of the trailer 3. Use of the embodiment shown in FIG. 6 of the coupling apparatus is essentially the same as use described in FIGS. 1 and 1A. The coupling apparatus 2 shown in FIG. 6 is particularly suited to towing vehicles with a short rear overhang.

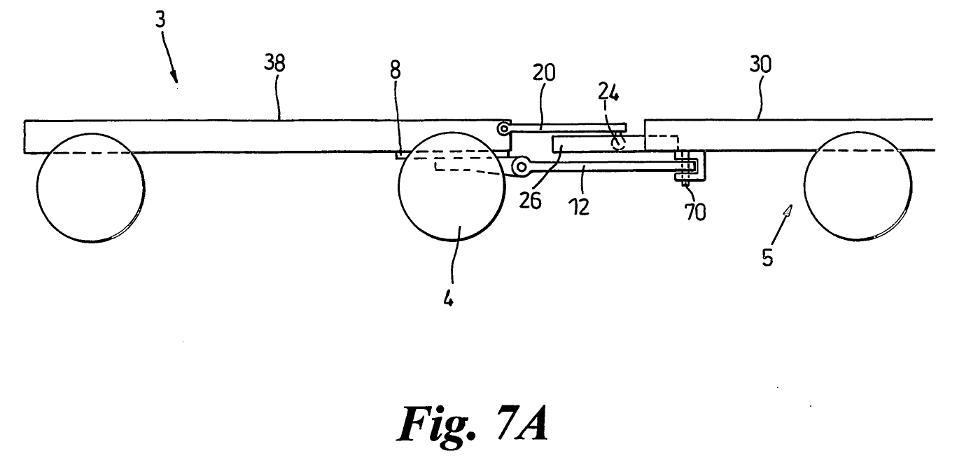

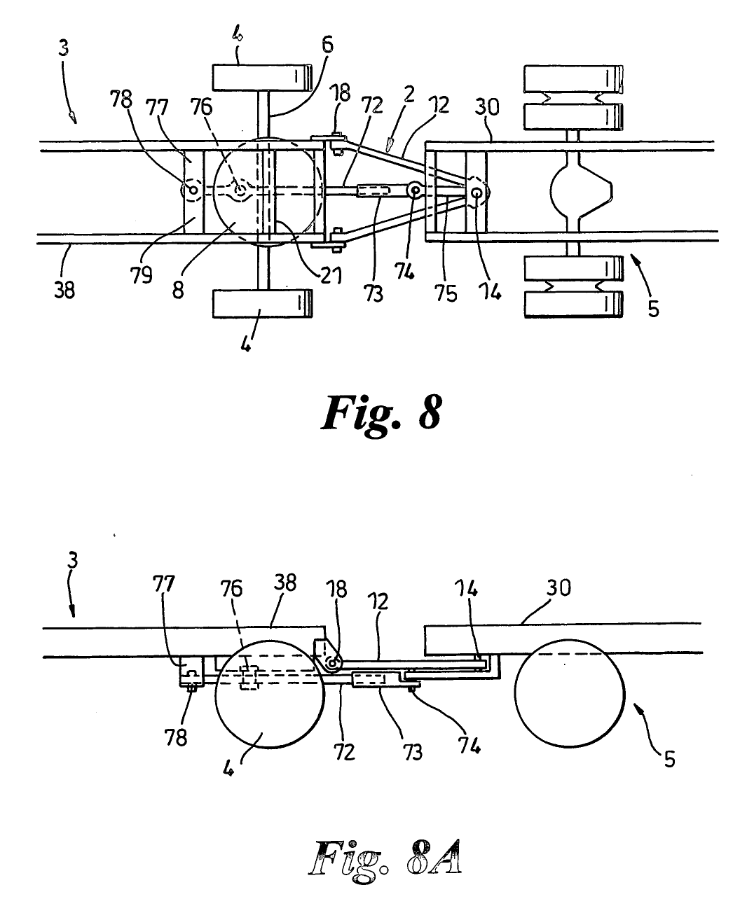

We turn now to FIG. 7 which illustrates another preferred embodiment of a coupling apparatus 2 of the invention, particularly suited to modifying existing A-frame tow bar trailers. The embodiment shown in FIG. 7 comprises a coupling apparatus 2 which is very similar to that shown in FIGS. 1 and 1A, and like numerals represent like components. In this embodiment, the tow bar 12 is connected to the chassis 30 of the towing vehicle 5 by a pivot 70. The slide tube 26 is rigidly connected to the chassis 30 of the towing vehicle 5. The slide channel 26 also extends rearwardly of the chassis 30 such that the distal end protrudes from the chassis 30 by some distance. The steering ball 24 of the steering bar 20 is effected to slide within the slide channel 26 as described herein above for that of the embodiment of FIGS. 1 and 1A.

In the embodiment shown in FIGS. 8 and 8A, the tow bar 12 is connected to the chassis 30 of the towing vehicle 5 via a pivot bar 14. A steering bar 72 is coupled with the chassis 30 of the towing vehicle 5 by way of a slide channel 73 pivotably connected to the towing vehicle 5 by way of a pivot 74 connected to the chassis 30 by an extension bar 75 extending rearwardly from the chassis 30. Thus the slide bar 73 protrudes from the chassis 30 rearwardly of the towing vehicle 5. The steering bar 72 is slidable within the slide bar 73 as described previously for other embodiments. The steering bar 72 includes at its other end, a connection point 76 which is fixably connected to the turntable 8. The turntable 8 is rotatably connected to the chassis 38 of the trailer 3 by way of a steering frame 21. The connection point 76 is also pivotably connected to a secondary pivot 78 connected on a cross beam 79 on the chassis 38. Thus, when a steering force is applied to the rear of the turntable 8 via the connection point 76 sliding movement is enabled between the steering bar 72 and slide channel 73. The double pivoting action at connection point 76 and pivot 78 of the trailer 3 serves to reverse the movement and points the trailer front wheels 4 in the correct direction of turning of the towing vehicle 5.

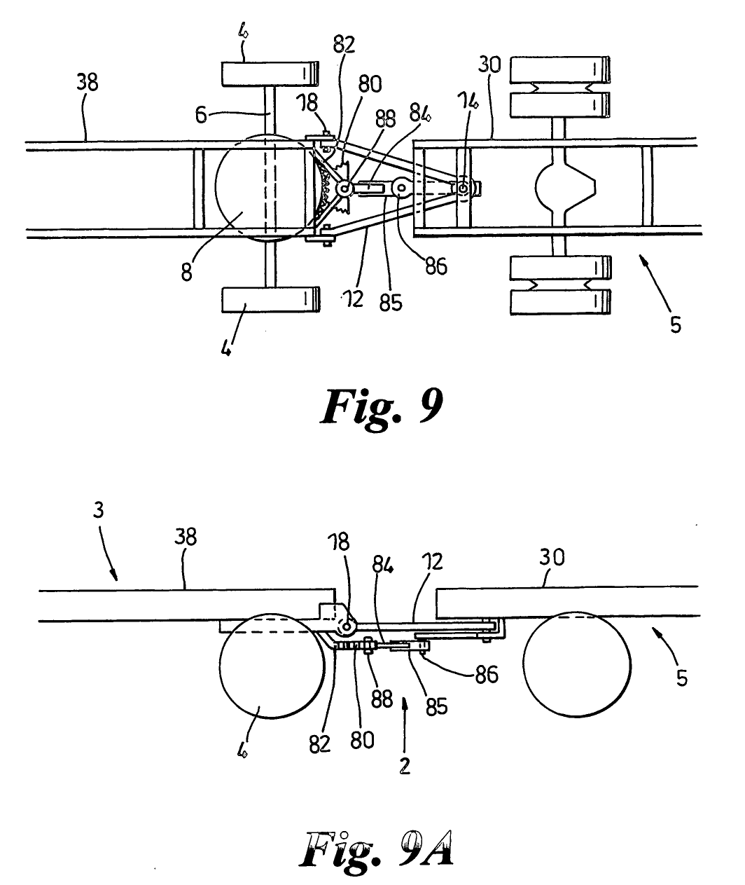

We turn now to FIGS. 9 and 9A which illustrate another preferred embodiment of a trailer coupling apparatus for the invention, similar to that shown in FIGS. 1 and 1A. Like numerals represent like components. In the embodiment shown in FIGS. 9 and 9A, the steering bar 84 is pivotably connected by pivot 88 to part of a toothed gear 80, which is cooperable with a toothed gear 82 extending part way around the periphery of the turntable 8. The steering bar 84 is slidable in a steering tube 85 which is pivotably connected at a pivot 86 to the chassis 30 of the towing vehicle 5. Thus movement of the towing vehicle 5 to the left or right creates pivoting of the slide tube 85 about the pivot 86, which enables the slide bar 85 to slide in towards the closed end of the slide tube 85. At the extent of sliding of the steering bar 84 into the slide tube 85, the turntable will then pivot by way of partial gear 80 pivoting about pivot point 88, in order to mesh with partial gear 82 on the turntable and cause rotation of the turntable 8 to rotate the wheels 4.

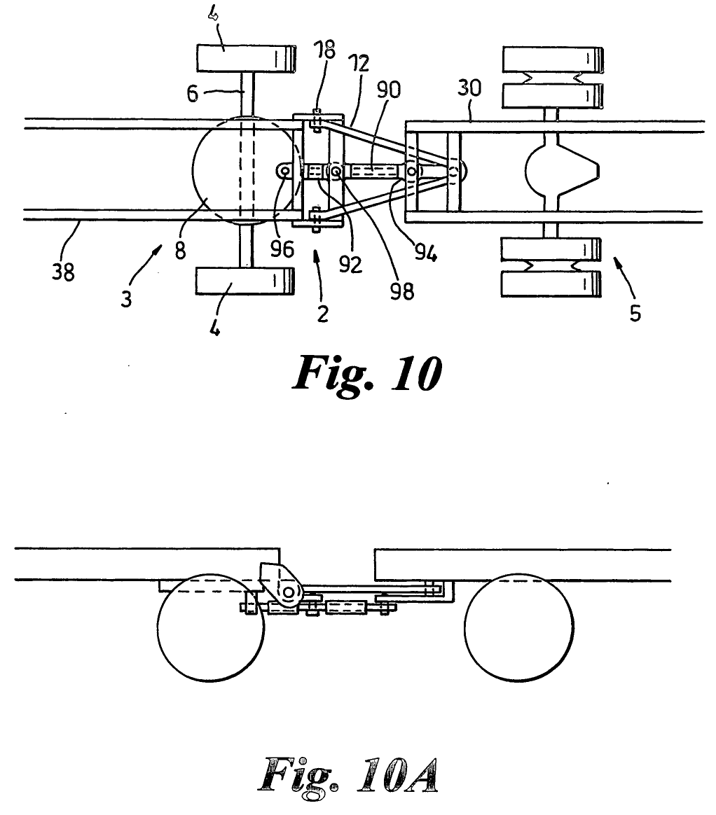

We turn now to FIGS. 10 and 10A which show yet another embodiment of the trailer coupling apparatus 2 of the invention, which is similar to that shown in FIGS. 1 and 1A. Like numerals represent like components. The apparatus 2 of FIGS. 10 and 10A includes a steering bar 90 which is connected near to its centre at a bracket 98 connected to the chassis 38 of the trailer 3. The steering bar 90 is connected to telescopic sections 94 and 92 one of which is each connected to the chassis 30 and 38 of the towing vehicle and trailer. Any variation in the length of the steering bar 90 is accommodated by two telescopic sections within it either side of the centre bracket 98.

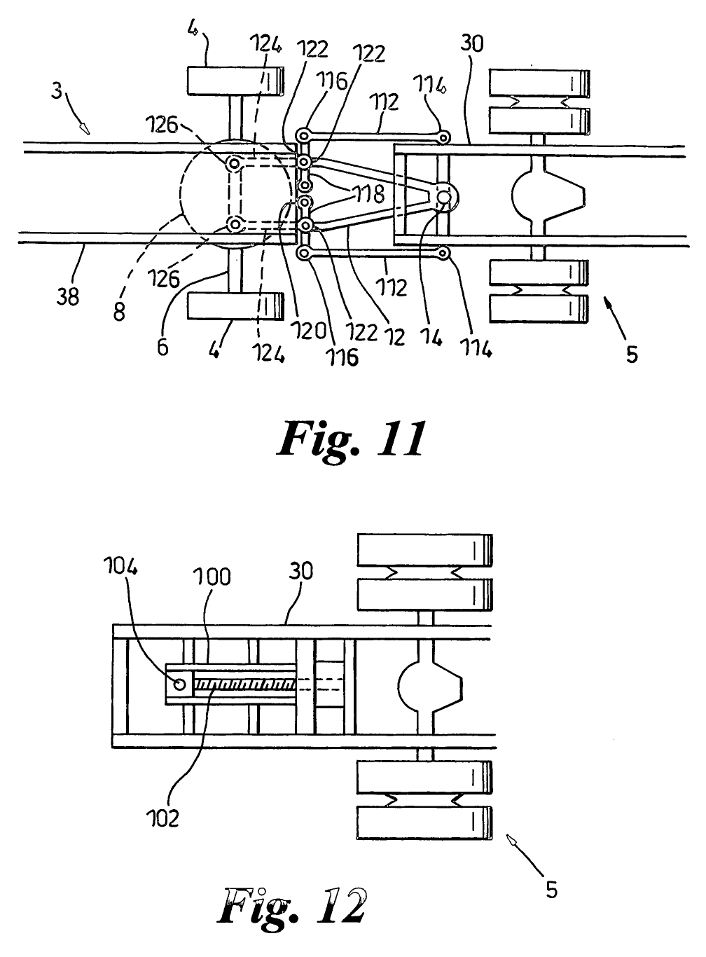

We refer next to FIG. 11 which illustrates a trailer coupling apparatus 2 similar to that shown in FIG. 4. Like numerals represent like components. The apparatus 2 of FIG. 11 includes a pair of steering bars 112 pivotably attached to the chassis 30 of the towing vehicle 5 by pivots 114 located either side of the rear end of the chassis 30. At the other end of the steering bars 112 is a second pivot 116, pivotably connected to a secondary steering bar 118, which in turn is pivotably connected to the front of the trailer 3 via pivots 120. The secondary steering bar 118 is arranged such that when the towing vehicle 5 and trailer 3 are in line and parallel, in the forward position, the steering bar 118 is perpendicular to the direction of travel of the towing vehicle 5 and trailer 3. Half way along the secondary steering bar 118 is a steering pivot 122 which is in turn integral with a tertiary steering bar 124, which is connected to the turntable 8 of the apparatus 2 via pivots 126. Use of the apparatus 2 shown in FIG. 11, as the towing vehicle 5 turns, for example to the right, this in turn will cause pivoting of the steering bars 112 about pivots 114, causing pivoting of the secondary steering bar 118 about the secondary pivot 120 having the effect of rotating the secondary steering bar 118 about pivot 120 away from the front of the trailer 3. As this happens, the tertiary steering bar 124 is urged to pivot about pivots 122 on the secondary steering bar 118, and is pulled forward with the rotational movement of the secondary steering bar 118, such that the turntable 8 is urged to rotate about pivots 126 in the direction of the turn of the towing vehicle 5, in order to pivot the pivotable wheels 4. The combined pivoting of the steering bars 112, 122 and 124 enables differential pivoting of the pivotable wheels 4 and the trailer 3 in relation to turning of the towing vehicle 5.

We refer next to FIG. 12 which illustrates a tow bar connection member 100 which may form part of a trailer coupling apparatus 2 according to the invention. The tow bar connector 100 is rigidly connected to the towing vehicle chassis 30 and includes a telescopic member 102, which may be adjusted to slidably move a tow bar connection pivot 104, to which is connectable a tow bar 12 as described from any of the preceding embodiments or any other embodiments of the invention. The telescopic tow bar connector 100 can be used if it is desired to increase or decrease the distance between the trailer 3 and towing vehicle 5 when the two are coupled together. Thus if it is desired to create a shorter distance between the front of the trailer 3 and the rear of the towing vehicle 5, the telescopic member 102 may be manipulated to slide the connection pivot 104 towards the front of the towing vehicle 5, in order to bring forward the tow bar 12 towards the rear of the towing vehicle 5, and reduce the distance between the two vehicles. The telescopic member 102 of the tow bar connection member 100 may be provided by a motor which can be operated by air, electricity of hydraulic means for example. The telescopic section 102 may comprise a rotatable member, which rotates around a screw thread in order to move the member 100 backwards and forwards as required. The motor can be activated by sensors (not shown) which can detect the angle of the steering bar or towing bar of the towing vehicle, or by detecting the distance of the trailer from the towing vehicle.

An alternative way to give more clearance between the towing vehicle and trailer, in further embodiments (not shown) when turning, is to raise the front of the trailer and/or lower the rear of the trailer by its suspension activated by sensors which detect the trailer moving to an angle to the towing vehicle, thus tilting the trailer away from the towing vehicle.

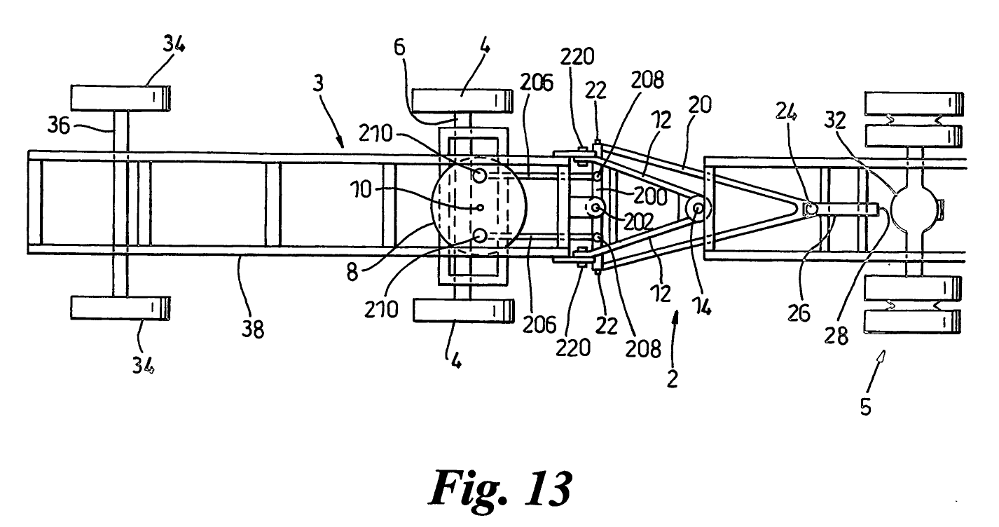

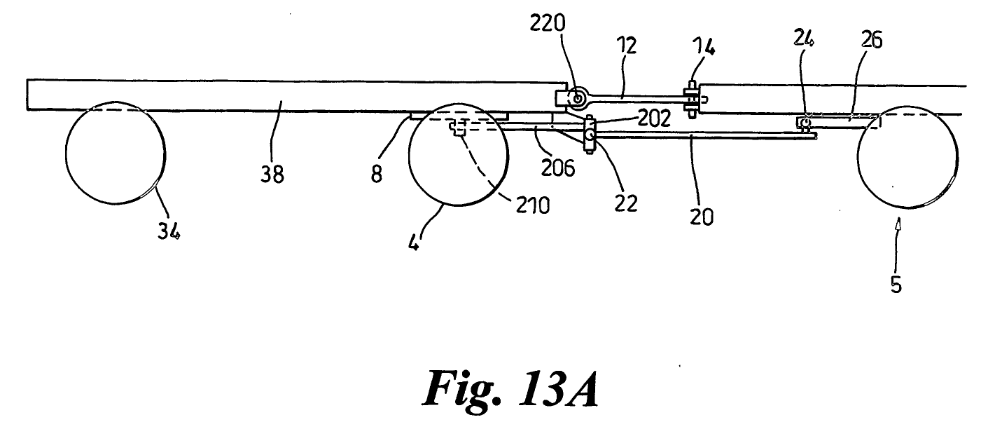

We refer now to FIGS. 13 and 13A which illustrate a ninth embodiment of the trailer coupling apparatus of the invention, coupled to a trailer 3 and a lorry 5. The coupling apparatus 2 is similar to the coupling apparatus shown in FIGS. 1 and 1A. Like numerals represent like components.

The coupling apparatus 2 includes a means to pivotally connect the trailer 3 to a towing vehicle 5 in the form of an “A-frame” tow bar 12 which at the distal end of the legs of the “A” are connected to the trailer chassis 38 via hinges 220. The apex of the A-frame 12 is connected to the towing vehicle 5 by way of a pivot 14 operably connectable to a pivot bar on the towing vehicle 5. The trailer coupling apparatus 2 further comprises means to effect differential pivoting of the trailer wheels 4 and trailer 3 with respect to the lorry 5, as the towing vehicle is turned in use, in the form of a v-shaped steering bar 20, at the end of which extends a horizontal bar 200 pivotally connected to the bar 20 about pivots 22. The bar 200 is rotatably connected to the chassis 38 of the trailer 3 via a pivot 202. The steering bar 20 is oriented such that it can be pivoted about the pivot 202 such that the apex of the steering bar 20 is rotated in the plane of the chassis 38. The pivots 22 enable the v-shaped steering bar 20 to pivot perpendicularly to the plane of the chassis 38, ie such that the apex of the steering bar 20 can be raised or lowered from and to ground level. The apex of the steering bar 20 is connected to a slide channel 26 on the lorry 5, by way of a steering ball 24, as described for FIGS. 1 and 1A.

In this embodiment, the steering bar 20 also includes secondary steering bars 206, connected on the bar 200 towards either end of the bar, by pivots 208. The other ends of the secondary steering bars 206 are connected to a turntable 10 or sub-frame on the trailer, at points 210. The turntable, as described in FIGS. 1 and 1A, is fixedly connected to the sub-frame and front wheels for the trailer 3.

The towing bar 12 operates in an identical manner to that described in the description for FIGS. 1 and 1A. The tow ball 24 of the steering bar 20 co-operates with the slide tube 26 on the lorry 5 chassis in an identical manner to that described for FIGS. 1 and 1A. In order to provide more effective means to enable differential pivoting of the chassis 38 and wheels 4 of the trailer, the trailer coupling apparatus 2 includes secondary steering bars 206 which, when the steering bar 20 pivots about pivot 202 during turning of the lorry 5, enable secondary steering by pivoting about points 208, in order to enable tighter turning of the wheels for the trailer 3 if desired. The apparatus described for FIGS. 13 and 13A is particularly suitable for towing vehicle and trailer combinations in which the trailer and/or towing vehicle are relatively elongated, and therefore may have trouble turning about roundabouts or other tight turns.

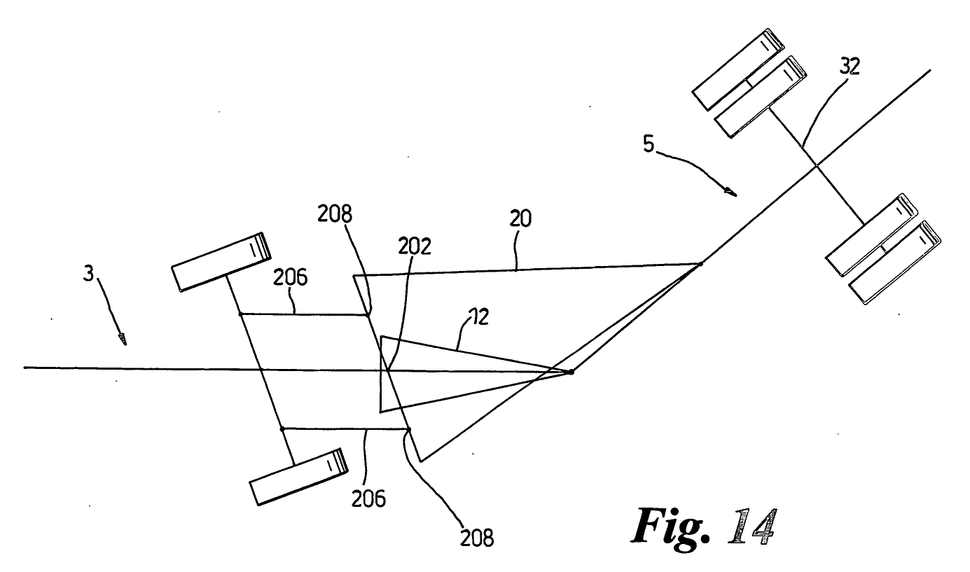

FIG. 14 illustrates a schematic plan view of the trailer coupling apparatus 2 described for FIGS. 13 and 13A with the trailer at an angle to the towing vehicle. It can be seen that the steering bar 20 pivots laterally on the pivot 202. This movement is translated to the trailer turntable or sub-frame by the secondary steering bars 206.

Although the invention is especially useful for commercial and industrial vehicles including lorries, trailers, flat back trailers, vans etc, the invention may well apply to couplings for model vehicles, toys and other miniature versions of coupled vehicles. For example, a miniature version of the coupling apparatus may be utilised to couple a toy trailer to a toy towing vehicle. The trailer coupling apparatus may be useful in die cast models and the like.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A trailer coupling apparatus comprising means to pivotably mount at least one left wheel and at least one right wheel to a trailer, independent means to pivotably connect the trailer to a towing vehicle and means to enable differential pivoting of the said wheels and trailer, with respect to the towing vehicle, as the towing vehicle is turned in use.

2. A trailer coupling apparatus as claimed in claim 1 wherein the trailer comprises a trailer chassis to which is mounted a fixed set of wheels and wherein the trailer coupling apparatus comprises a set of wheels being pivotably mountable to the trailer.

3. A trailer coupling apparatus as claimed in claim 2 wherein the pivotable wheels of the apparatus are connected to an axle which is mounted on a pivotable member.

4. A trailer coupling apparatus as claimed in claim 1 wherein the pivotable wheels are connected to pivotable kingpins.

5. A trailer coupling apparatus as claimed in claim 1 wherein the means to pivotably connect the trailer to a towing vehicle comprise a suspension means, and/or means to bias the connection means onto the towing vehicle in use.

6. A trailer coupling apparatus as claimed in claim 1 wherein the means to pivotably connect the trailer to a towing vehicle comprises a tow bar.

7. A trailer coupling apparatus as claimed in claim 6 wherein the tow bar comprises a female or male member at the distal end thereof, arranged in use to co-operate with the corresponding male or female member on the towing vehicle.

8. A trailer coupling apparatus as claimed in claim 6 wherein the tow bar comprises means to prevent the distal end of the tow bar from falling to ground level when it is not coupled to a towing vehicle.

9. A trailer coupling apparatus as claimed in claim 1 wherein the pivotable wheels are arranged to pivot in the turning direction of the towing vehicle, in use.

10. A trailer coupling apparatus as claimed in claim 1 wherein the means to effect differential pivoting of the pivotable wheels and the trailer comprise restriction means, arranged in use to delay or reduce the magnitude of pivoting of the wheels with respect of the trailer until the towing vehicle has turned a prescribed angle.

11. A trailer coupling apparatus as claimed in claim 10 wherein the restriction means effects restriction of pivoting of the pivotable wheels of the trailer to a fraction of the angle effected between the trailer and the towing vehicle chassis upon turning/pivoting of a towing vehicle to which the trailer is connected, in use, until the towing vehicle has turned a prescribed angle.

12. A trailer coupling apparatus as claimed in claim 11 wherein the restriction means enables movement of the pivotable wheels of the trailer in the direction the towing vehicle turns, in use, and effects a restricted angle of turning of the pivotable wheels in relation to the turning arc of the towing vehicle.

13. A trailer coupling apparatus as claimed in claim 10 wherein the restriction means comprises means to enable substantially optimal orientation of the pivotable wheels of the trailer, in relation to the orientation of the towing vehicle, in use, as the towing vehicle is turned.

14. A trailer coupling apparatus as claimed in claim 10 wherein the restriction means effects restriction of pivoting of the wheels to an angle of no more than 85% of the angle turned by the towing vehicle.

15. A trailer coupling apparatus as claimed in claim 10 wherein the restriction means comprises a steering member, moveably mountable on a channel member.

16. A trailer coupling apparatus as claimed in claim 15 wherein the channel member comprises an open end and a closed end.

17. A trailer coupling apparatus as claimed in claim 16 wherein the open end is operably co-operable with the steering member to enable movement between the steering member and the channel member.

18. A trailer coupling apparatus as claimed in claim 16 wherein the closed end of the channel member is arranged in use to restrict movement of the steering member to within the channel member.

19. A trailer coupling apparatus as claimed in claim 15 wherein the steering member comprises a steering bar.

20. A trailer coupling apparatus as claimed in claim 19 wherein the steering bar comprises a protruding member at or near the distal end thereof, arranged to co-operate with the channel member of the restriction means.

21. A trailer coupling apparatus as claimed in claim 20 wherein the protruding member comprises a substantially spherical member and the channel member comprises a channel or substantially cylindrical cross-section.

22. A trailer coupling apparatus as claimed in claim 15 wherein the steering member or channel member includes a plurality of gear teeth, arranged to co-operate with the corresponding plurality of teeth on a turntable to which the pivotable wheels are connected.

23. A trailer coupling apparatus as claimed in claim 10 wherein the restriction means comprises a plurality of pivotable arms, at least one of said arms being connectable to the pivotable wheels and at least one of said arms being connectable to a towing vehicle in use, and wherein the maximum pivotable arc achievable by the pivotable wheels is restricted by the maximum pivot achieved by the plurality of arms.

24. A trailer coupling apparatus as claimed in claim 10 wherein the restriction means comprises a telescopic member.

25. A trailer coupling apparatus as claimed in claim 10 wherein the apparatus comprises secondary restriction means, which in use, are connectable to the trailer and which restrict upward and downward movement of the pivotable wheels during turning of the trailer.

26. A trailer coupling apparatus as claimed in claim 25 wherein the secondary restriction means comprise one or more buffers co-operable with each pivotable wheel and which are arranged to protrude towards the ground from the trailer adjacent to the trailer's front wheel axle or axles.

27. A trailer comprising at least one pivotable front left and right wheel, and further comprising means to independently pivotably connect the trailer to a towing vehicle and means to enable differential pivoting of the trailer wheels and trailer, in relation to the towing vehicle, as the towing vehicle is turned in use.

28. A trailer as claimed in claim 26 wherein the pivotable wheels are mounted to a turntable located beneath the trailer.

29. (canceled)

30. A method of connecting a trailer to a towing vehicle, comprising the steps of: (a) connecting means to pivot at least one front left and right wheel to the trailer; (b) connecting means to independently pivotably connect the trailer to a towing vehicle, to a trailer and towing vehicle; and (c) connecting means to effect differential pivoting of the trailer wheels and trailer to the trailer and towing vehicle.

31. A method as claimed in claim 30 wherein steps (a), (b) and (c) are performed in any order.

32. (canceled)
